(19) United States
(12) Patent Application Publication
(10) Pub. No.: US 2011/0153402 A1
(43) Pub. Date: Jun. 23, 2011

(54) Methods and Apparatus for Credit Card Reward and Cost Management

(76) Inventor: Jack Wells Craig, Ovideo, FL (US)

(21) Appl. No.: 12/645,649

(22) Filed: Dec. 23, 2009

(51) Int. Cl. G06Q 30/00; G06K 5/00; G06Q 10/00; G06Q 40/00; G06Q 20/00

(52) U.S. Cl. 705/14.27; 235/380; 705/30; 705/35; 705/26.7

(57) ABSTRACT

Systems and techniques for selecting accounts to be used for purchases. A consumer's financial information, including status, terms, and reward programs of various credit card accounts associated with the consumer is stored and examined to determine the relative value of the use of each card account for purchases in each of various categories, with the determination including consideration of the rewards available for a purchase with the card account compared to the costs for use of the card account. Recommendations are provided to a consumer based on the determination of the relative value of the use of each card account, including one or more of specification of a selection of preferred card accounts for use during a specified period, specification of preferred card accounts for each of one or more purchase categories, or specification of a recommended card account to be used for a purchase based on purchase details.

### FIELD OF THE INVENTION

The present invention relates generally to improved systems and techniques for credit card management. More particularly, the invention relates to improved systems and techniques for analyzing reward and cost characteristics of available credit cards of a consumer and selecting or recommending an advantageous card for a particular purchase.

### BACKGROUND OF THE INVENTION

The use of credit cards for purchases has brought considerable convenience to consumers, with one prominent feature of many credit cards being the ability to earn rewards such as airline frequent flyer miles, hotel points, general use points, cash rebates, and other benefits with purchases. Many consumers carry numerous different credit cards, and earn points, miles, and rebates from several different credit cards. Credit cards have also traditionally offered consumers the convenience of charging purchases at a number of different merchants during a month and paying for the purchases later, after presentation of the credit card statement. Credit cards also offer consumers the ability to pay for their charges over a period of months, but the interest costs associated with such a practice can be substantial, particularly when consumers continue to make charges when they are carrying an unpaid balance at interest.

### SUMMARY OF THE INVENTION

In its several aspects, the present invention recognizes that the analysis of the reward programs of different credit cards, and the balancing of the value of the reward programs against the interest cost of carrying a balance can be a complex undertaking, but that a carefully conducted analysis can lead to significant rewards. One important decision resulting from such an analysis is the choice of credit card for any particular purchase. Different credit cards have different reward structures, and some cards may provide greater rewards for purchases at specific merchant categories, such as gasoline stations or supermarkets. In addition, the consumer's own particular circumstances may influence the desirability of earning points from a particular program. For example, if a consumer is earning points in an airline program and the point cost for a domestic round trip ticket is 25,000 points, the value to the consumer of an additional 100 points is much greater if the consumer's point total is 24,900 points than if it is 723 points.

Numerous additional factors may be considered, such as the existence of a zero percent period for purchases for a particular card, the prevailing interest rate available to the consumer for savings, the interest rate for a card for which the consumer may consider carrying a balance, the presence of an annual cap on the points that may be earned for a particular card. For any purchase to be made by a consumer, all of these factors may enter into an analysis to determine the optimal card to be used by a consumer.

The nearly ubiquitous presence of computers and data processing devices in the lives of consumers provides a consumer with numerous platforms that may be used to conduct analyses of the daily activities of consumers. The use of computers by many consumers to analyze the consumers' financial activities provides, in many cases, a ready source of information that can be analyzed in making financial decisions, and the use by many consumers of personal data processing devices gives such consumers ready access to the information, and the computing power for processing of information, needed to enhance their decisions.

A system according to an aspect of the present invention therefore comprises a consumer data processing device, such as a personal computer, storing or having access to a consumer's personal financial and other details, including the details of the consumer's various credit cards. Such details may include details of reward programs associated with the cards, credit limits and interest rate of each card, balance and payment history of each card, reward point totals and redemption requirements for each card, and any other information useful in determining which card may be more advantageously used in particular circumstances. The personal computer may suitably communicate over a network such as the public Internet with various financial and other information management servers used by the consumer and may periodically examine or download the relevant information. The personal computer may suitably communicate with a consumer personal data device which may also store credit card information needed to make transactions. For example, a consumer's wireless device may provide a capacity for use as an electronic wallet storing credit card details and communicating the needed details to a merchant terminal for a transaction.

One or more of the personal computer, the personal data device, or other data processing equipment of the consumer maintains consumer personal data as well as analysis software for analyzing proposed transactions and selecting a card to be used for the transaction. The analysis may suitably be conducted using a scoring system that assigns a score to each card based on the transaction details and the personal circumstances of the consumer. For transactions that may be conducted using an electronic wallet, the consumer personal device may suitably store the consumer's financial details and other information and perform the analysis itself, may communicate with the consumer's personal computer to receive the results of an analysis of a proposed transaction, or may conduct the analysis based on factors that provide scoring based on the transaction without a need to store the consumer's details in a device which might be more subject to theft than a personal computer stored in a secure location. For online shopping, analysis may be performed by the device used to conduct the online shopping, such as the personal computer, a notebook computer, or a personal data device. For transactions conducted by physical presentation of a card to a merchant, the personal computer may prepare a list of cards to be taken with the consumer based on the consumer's estimated spending for the day and the analysis may be conducted by the consumer's personal device, which may issue a recommendation for each purchase. Alternatively, the personal computer may simply prepare a notice to the consumer advising the consumer which cards are to be used under what circumstances, or may receive communications from the consumer and respond to the consumer by indicating what card is to be used for a transaction.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a system for analysis and selection of credit cards according to an aspect of the present invention; and

FIG. 2 illustrates a process of analysis and selection of credit cards according to an aspect of the present invention.

### DETAILED DESCRIPTION

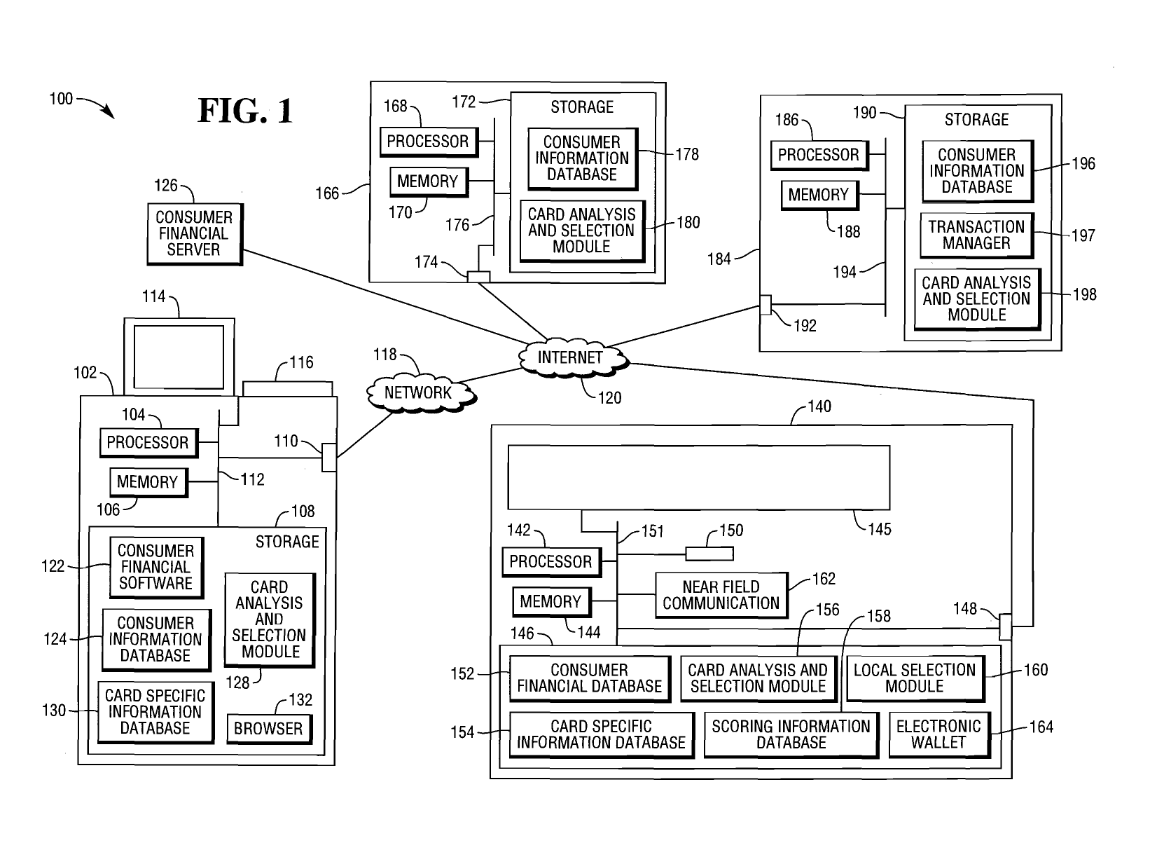

FIG. 1 illustrates a system 100 for analysis and selection of credit cards to be used for a transaction according to an aspect of the presenting invention. The system 100 includes a consumer personal computer 102, comprising a processor 104, memory 106, storage 108, and network interface 110, communicating over a bus 112. The computer 102 further comprises a display 114 and keyboard 116, and communicates with various other data processing devices and systems over a network 118, which may provide access to the public Internet 120. A personal computer is discussed here as an example, but it will be recognized that the operations described here as conducted by the personal computer 102 may be conducted by any device having appropriate data processing capabilities.

The personal computer 102 implements consumer financial software 122, suitably implemented as software residing in storage 108 and transferred to memory 106 as needed for execution by the processor 104. The consumer financial software 122 creates and stores a consumer financial database 124. The database 124 stores consumer asset and transaction information, including information relating to the consumer bank accounts, investment accounts, loan accounts, credit card accounts, reward accounts, and any other accounts that may be affected by transactions entered into by the consumer. The personal computer 102 communicates with one or more financial or other servers managing consumer financial, reward, and other relevant information such as the consumer financial server 126, periodically downloading updated information relating to the various consumer accounts. Financial information, as discussed here, may include any consumer information relating to the accumulation, management, and expenditure of value, whether actual monetary value such as monetary deposit and debt accounts, or rewards, reward points, and other mechanisms of exchange for items of value to the consumer.

The information that may be downloaded from servers such as the server 126, managed by the software 122, and stored in the database 124 may suitably include reward account balances so that the consumer may have more or less continual access to a current view of all of his or her financial and reward information, with the database 124 maintaining updated reward balance and transaction information.

The personal computer 102 also implements a card analysis and selection module 128. The card analysis and selection module 128 maintains a card specific information database 130, which includes information extracted from the consumer financial database 124, and may include credit card information such as credit limits, required minimum payment, reward point availability, nature of reward points earned, earning rate of reward points, enhanced point earning based on nature of merchant, bonus period, special promotions, and similar data. Also stored is information relating to expiration conditions and dates for points in various programs and earning caps for points from various cards and in various programs. In addition, information is stored relating to the availability of points from other sources, such as earning airline miles by flying on the sponsoring airline, and the anticipated earning rate of points from such sources.

If such information is not present in the consumer financial database 124 for a particular card, it may be added to the database 130 through communication with a consumer informationserver, such as the server 126, through a specific inquiry, or may be entered directly by the consumer. Additional information that may be important to the consumer but may not ordinarily be considered by typical consumer financial software such as the software 122, may include specific information relating to the rewards that may be earned using the points, the desirability of particular rewards to the consumer, and identification of rewards that represent specific goals being pursued by the consumer, such as a target for cash redemption, a gift card, an air ticket, a hotel stay, or a vacation package, and such information, as well as any other information relevant to choosing an optimal credit card for a transaction, may be stored in the database 130.

Such additional information may include information relating to the value of the ability to extend a payment period. Some credit cards offer a promotional interest free period for purchases that extends beyond the typical one month period, and the ability to take advantage of such an interest free period provides the consumer with the opportunity to earn interest before needing to pay the balance on the card. The value of such an opportunity depends on the after tax interest the consumer can expect to earn on his or her savings, so that the value of extending payments depends on the expected interest rate available as well as the consumer's marginal tax rate. Such earnings potential may be balanced against superior rewards on cards that do not offer such extended payment terms.

The interest rate and terms associated with each card are also stored, to allow for analysis of the interest costs of purchases using a card for which the consumer is carrying a balance or expects to carry a balance. In many cases, if a consumer has carried a balance for one statement period, all purchases during the next statement period are charged interest from the date of purchase, and such information may be used to analyze the costs of using a card for which a balance is already owing and the advantages of using a different card.

In one exemplary embodiment, the card analysis and selection module 128 examines the information in the databases 124 and 130 and assigns a score to each card for purchases in each category. Some cards have only one purchase category, because all purchases made with the card earn the same rewards, but some cards have multiple purchase categories, so that the use of a card for a purchase in a general category may have a low score and a use of the card for a purchase in a special category may have a higher score. In addition, particular card issuers may operate promotions for specific merchants or categories of merchants, or may have ongoing relationships with particular merchants, so that the use of a particular card for a merchant associated with a promotion or a special relationship may earn points at a higher rate.

Any number of desired scoring mechanisms may be employed, such as a scoring mechanism assigning actual cash value to such factors as interest costs and cashback rewards, and a cash equivalent value to reward points, with the cash value assigned to reward points being higher when the point total is near a level required to achieve a desired reward. The valuation assigned to reward points from different programs may vary. For example, reward points associated with a program regularly used by the consumer may be given a higher value.

Whenever a purchase is contemplated, if details of the purchase are provided to the card analysis and selection module 128, the card analysis and selection module 128 may score each card with respect to the purchase and either recommend the highest scoring card or simply select the highest scoring card for the purchase, depending on consumer preferences. One exemplary approach, particularly useful for cases in which the use of a card may be determined to be the most advantageous but nevertheless has disadvantageous aspects, is to present an explanation of the advantages and disadvantages of the use of a card for a particular purchase. For example, the use of a card for which the consumer is carrying a balance at a nonpromotional interest rate typically carries costs that overcome the value of any rewards that may be earned, but there may be cases in which the use of the card will achieve an important goal of the consumer, such as completing the points requirement for an intercontinental flight. When such a card is presented for consideration, an explanation of the disadvantage of making a purchase using a card that carries a balance may be presented, together with an explanation of the goal that will be achieved.

In such cases, or if the consumer has made a general choice to receive a recommendation, the card analysis and selection module 128 may offer details explaining the reason for the scoring and may present alternative cards. Such an analysis of a purchase is particularly useful for online shopping, in which the consumer may use the computer 102 and information relating to the purchase is directly available to consumer who is using the computer 102 for the transaction. In such transactions, the computer 102 employs a browser 132 and the card analysis and selection module 128 may examine web page information collected by the browser to determine details of the transaction, select a preferred card for completing the transaction, and present a selection pop-up allowing the consumer to select a desired card, or simply fill in the transaction page with the card information. In addition, the card analysis and selection module 128 may also recommend shopping portals that can be used to increase the earning potential. Many reward programs maintain shopping portals, and purchases made through those portals can earn points. The consumer financial database 122 may suitably maintain information identifying the various shopping portals associated with the reward programs in which the consumer participates, and when the consumer begins a transaction at a merchant participating in such a shopping portal, the card analysis and selection module may suggest conducting the purchase through an appropriate shopping portal. Often, points can be earned through a shopping portal whether or not the credit card being used earns rewards in the same program, so that the card analysis and selection module may at times recommend using a card earning points in one program for a purchase made through a shopping portal earning points in another program, depending on the overall net value of each choice.

As an alternative or in addition to analyzing each transaction as it occurs, the card analysis and selection module 128 may simply score the consumer's cards and create a list of preferred cards, with a primary card and one or more secondary cards for each category of transactions that may be expected to be entered into. The card analysis and selection module 128 may present the list to the consumer by any mechanism desired, such as presenting an alert display, sending an email or text message, or transmitting the list to the consumer's wireless device or personal organizer, such as a data capable portable telephone or other communication device. Such a list may be particularly useful when the consumer is preparing for a trip, so that it will not be convenient for the consumer to select different cards until he or she returns from the trip, and the consumer may be expected to engage in transaction categories for which particular cards may be particularly useful. For example, it may be particularly desirable to purchase a ticket using a card associated with the miles program of the airline on which the flight is to be made, a car rental may best be made with a card offering the best accident insurance program, and so on.

The system 100 may also include a consumer personal device 140, which may take the form of a data enabled mobile telephone, having the capacity to operate as personal digital assistant. The consumer personal device 140 may include data communication capability through wired connection with the computer 102, wireless communication, and data processing capabilities. An exemplary personal device 140 includes a processor 142, memory 144, display 145, storage 146, data port 148, and transceiver 150, communicating over a bus 151.

The computer 102 may transfer any information needed for analysis of credit cards to the consumer personal device 140. For example, the personal device may implement its own copies 152 and 154, respectively, of the databases 124 and 130, and its own copy 156 of the card analysis and selection module 128, and may score and select cards based on the stored data and the details of the transaction to be entered into. Alternatively, the computer 102 may simply transfer scoring information to the consumer personal device 140. The scoring information may reside in a scoring information database 158, and the personal device 140 may implement a local selection module 160 to select a card based on transaction details. Such an approach avoids storing a copy of sensitive personal data on a portable device. As a further alternative, the personal device 140 may simply transmit details of a proposed transaction to the computer 102, which may perform the analysis and return a selection.

As a further alternative, particularly useful if the personal device 140 is equipped with a near field communication mechanism 162, the personal device 140 may provide an electronic wallet 164. The electronic wallet 164 stores information for each of the consumer's credit cards sufficient to provide the necessary information for a transaction using the credit card. Depending on the particular design of the personal device 140, the device may use the card analysis and selection module 156 or the local selection module 160, or may communicate with the personal computer 102 to select a card, and either directly selects a card or makes a recommendation to the consumer for a selection. Upon selection of a card, the electronic wallet retrieves details of the selected card and uses the near field communication mechanism to transmit card details to a suitably equipped merchant terminal for the transaction.

As an alternative or in addition to the use of the computer 102, the system may include a service provider server 166 capable of providing services to numerous consumers through communication over the Internet 120 or any other suitable communication medium. The server 166 includes a processor 168, memory 170, storage 172, and network interface 174, communicating over a bus 176. The server 166 suitably employs a consumer information database 178 and a card selection and analysis module 180, residing in the storage 172. The server 166 communicates with consumers subscribing to card selection services provided by an entity by or for which the server 166 is operated, with subscriptions being supported in any number of ways, such as through payment, through advertising support, or as a free service offered, for example, by a financial institution, a credit card issuer, a merchant, or any other entity desiring to offer such services. The server 166 may receive consumer information such as is stored in the database 124 of the computer 102, and may simply retrieve data through communication with devices operated by the consumer without retaining consumer data, or may securely store consumer data for a plurality of consumers in the consumer information database 178, with the data for each consumer for whom services are provided using such stored data being stored separately and securely. For each consumer who provides appropriate consent, data may be used to improve services. For example, data may be aggregated to refine estimates of the valuations that may be applied to various reward point programs and to help determine the conditions under which reward points are more or less valuable.

The card analysis and selection module 180 receives appropriate consumer data, whether from the computer 102, the database 178, the personal device 140, or any other source, and performs credit card selection in was similar to those described above, delivering results to the consumer by directing information to a device transmitting a request, to a destination specified by the consumer, such as an email, instant messenger, or short message service destination, to a merchant transaction form such as an online shopping form or a suitably equipped merchant terminal, or to any of a number of other destinations that may be desired by the consumer.

The system 100 may also include a merchant server 184, providing credit card analysis and selection services for transactions with the merchant by or for whom the server 184 is operated. The server 184 includes a processor 186, memory 188, storage 190, and network interface 192, communicating over a bus 194. The server 184 suitably employs a consumer information database 196, a transaction manager 197, and a card analysis and selection module 198. The server 184 provides services to customers of the merchant subscribing to such services and providing appropriate information, or access to appropriate information, to the server 184. As discussed above with respect to the server 166, the server 184 may receive information from an appropriate consumer device or may store information relating to one or more consumers. When a consumer begins a transaction with a merchant using the server 184, the transaction manager 197 invokes the card analysis and selection module 198, which analyzes consumer information to select a preferred card for the transaction, or a list of candidates for cards to be used for the transaction, and provides the card information to the transaction manager 197, either automatically or upon selection or confirmation by the consumer.

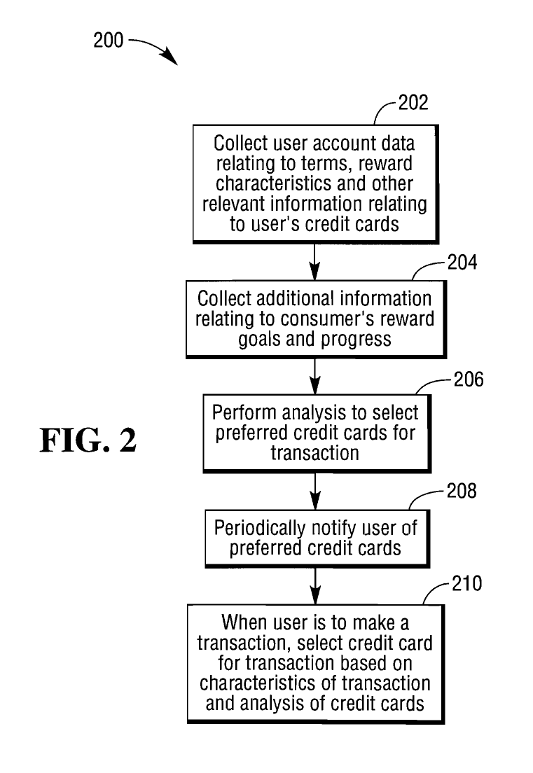

FIG. 2 illustrates the steps of a process 200 of credit card analysis and selection according to an aspect of the present invention. The process 200 may suitably be carried out using a system such as the system 100 of FIG. 1, using one or more devices such as the consumer computer 102, the personal data device 140, the service provider server 166, or the merchant server 184. At step 202, consumer account data, such as data relating to terms, interest rates, balances, required payments, rewards programs, and reward balances of consumer credit cards is collected and stored. Collection may suitably be accomplished by automated periodic inquiry from one or more consumer information servers storing consumer account information, by direct entry from a consumer, by analysis of consumer financial activities, or by any other desired mechanism, and storage may be advantageously accomplished by storing the information in a computer accessible memory. At step 204, additional information relating to consumer credit cards is collected, including consumer goals relating to various reward programs offered by the credit cards, and progress toward achieving those goals, and the information is stored, suitably in a computer accessible memory. At step 206, an analysis is performed, suitably by a processor examining the stored financial and additional consumer information, to identify preferred credit cards for transactions, based on the nature of the transactions, the goals of the consumer, the terms and balances of the credit cards, and the characteristics of rewards programs associated with the credit cards. Identification of preferred credit cards may suitably be accomplished by assigning scores to the various credit cards. At step 208, the consumer is periodically alerted as to the preferred credit cards for transactions to allow the consumer to select physical credit cards to be taken with the consumer. At step 210, when the consumer is to make a transaction, the credit cards are analyzed and a preferred credit card is selected for the transaction. Selection may suitably be accomplished by analyzing the transaction and notifying the consumer of the preferred card for the transaction, selecting stored card information during an online shopping session and providing the card information to complete the transaction, retrieving stored card information from an electronic wallet stored in a personal data device and transmitting the card information to a merchant terminal.

While the present invention is disclosed in the context of a presently preferred embodiment, it will be recognized that a wide variety of implementations may be employed by persons of ordinary skill in the art consistent with the above discussion and the claims which follow below.

I claim:

1. A data processing system for recommending a credit card to be used in a transaction, comprising:
a computer memory for storing financial information for a consumer, the financial information including credit card account information relating to credit card accounts associated with the consumer, the credit card information including reward program terms for reward programs associated with one or more of the credit card accounts; and
a processor for examining the financial and terms information and generating selection information identifying one or more preferred credit card accounts to be used for one or more categories of transactions, the selection information being based on an analysis of rewards earned through use of the credit cards accounts versus costs of using the credit card accounts.

2. The system of claim 1, further comprising a data interface for receiving consumer financial and credit card data from one or more financial servers and updating the stored financial and terms information based on the received financial and credit card account data.

3. The system of claim 1, wherein the information relating to the rewards programs includes information relating to categories of purchases earning rewards at a higher than usual rate for one or more of the credit card accounts.

4. The system of claim 1, wherein the selection information includes a score assigned to each credit card account for each of one or more transaction categories.

5. The system of claim 1, wherein the processor is operative to receive details of a transaction and to recommend the use of a shopping portal for the transaction when such use of a shopping portal provides an opportunity to earn points for the transaction.

6. The system of claim 1, further comprising a data interface for receiving details of a purchase transaction, and wherein the processor selects an optimum credit card account for use in payment for the purchase transaction.

7. The system of claim 7, wherein the memory stores credit card information for one or more credit card accounts of the consumer sufficient to authorize a purchase using the credit card account, and communicates credit card information for the selected optimum credit card account to a transaction terminal to authorize a purchase.

8. The system of claim 1, wherein the processor is operative to analyze financial information relating to the consumer and to prepare a list of preferred credit cards for use during a specified time period based on the consumer's anticipated transactions during the time period.

9. The system of claim 1, wherein the memory stores information associated with a plurality of consumers and wherein the processor is operative to separately examine the information associated with each consumer and generate selection information for each consumer.

10. The system of claim 10, wherein the processor is operative to aggregate information from each of a plurality of consumers and process the aggregated information to refine selection criteria.

11. The system of claim 1, wherein the memory stores information relating to a plurality of consumers who are customers of a merchant and wherein the processor is operative to provide selection information in response to information relating to a transaction between the merchant and a customer.

12. The system of claim 11, wherein the memory stores credit card account information for one or more consumers and wherein the processor retrieves the credit card account information for a selected credit card account and completes the transaction using the credit card account information.

13. A portable data device for selecting a credit card account to be used for a transaction, comprising:
a communication interface for receiving selection information relating to credit card accounts associated with a consumer, the selection information being received from a data processing system generating the selection information based on an analysis conducted by the data processing system of financial and terms information relating to the credit card accounts;
a data interface for receiving details relating to a purchase transaction; and
a processor for selecting a credit card account for use in the transaction based on the selection information.

14. The portable data device of claim 3, further comprising a near field communication interface for communicating credit card data for the selected credit card account to a transaction terminal.

15. A method of credit card account analysis and selection, comprising the steps of:
storing consumer financial data in a computer memory, the financial data including credit card data relating to terms of credit card accounts associated with the consumer including terms of reward programs associated with the credit card accounts;
controlling a processor to analyze the financial data to generate selection information indicating one or more preferred credit card accounts for use in each of one or more categories of transactions, the selection information being based on an analysis of the rewards earned through use of each of the credit card accounts balanced against the costs of using each of the credit card accounts.

16. The method of claim 15, wherein the information relating to the rewards programs includes information identifying purchase categories earning rewards at a higher than usual rate.

17. The method of claim 15, further comprising a step of storing information relating to consumer reward goals in the computer memory and wherein the selection information is based at least on part on an analysis of the incremental rewards needed to reach specified goals.

18. The method of claim 15, further comprising a step of receiving transaction information for a purchase and controlling the processor to select an optimum credit card account to be used for the purchase.

19. The method of claim 15, further comprising a step of transmitting credit card information for the selected credit card account to a transaction terminal.

20. The method of claim 15, further comprising a step of controlling the processor to analyze the consumer financial information to identify categories of purchases expected to be made during a specified time period and to prepare a list of preferred credit cards for use during the specified time period.
